(19) United States
(12) Patent Application Publication
(10) Pub. No.: US 2011/0267277 A1
(43) Pub. Date: Nov. 3, 2011

(54) Thumb Operated Tablet Remote Control

(75) Inventors: Howard S. Balch, Bloomingdale, NJ (US); Philip L. Kirkpatrick, Dumont, NJ (US)

(73) Assignee: Crestron Electronics, Inc., Rockleigh, NJ (US)

(21) Appl. No.: 12/772,535

(22) Filed: May 3, 2010

(51) Int. Cl. G06F 3/02

(52) U.S. Cl. 345/169

(57) ABSTRACT

Presented is a thumb-operated tablet remote control capable of being operated while being held in space by a user. The remote control includes a first control button and a second control button located on opposing edges as well as a display screen located between the first control button and second control button. The display screen is capable of showing a graphic interface of menu options organized into two tiers.

### BACKGROUND OF THE INVENTION

1. Technical Field

The present invention is directed toward the field of small, hand-held electronic devices such as remote controls and the like.

2. Background Art

Home automation systems and sophisticated home theaters are increasingly common features in households. Homeowners now have the ability to remotely control and monitor most aspects of their home environment including audio-visual equipment, lighting, HVAC equipment and security systems. As such, remote controls have become an integral part of any home theater or home automation system. Increasingly, users demand a simple and convenient method to remotely input control commands to the various controlled devices in their home. There is now a desire for a more capable and convenient remote control.

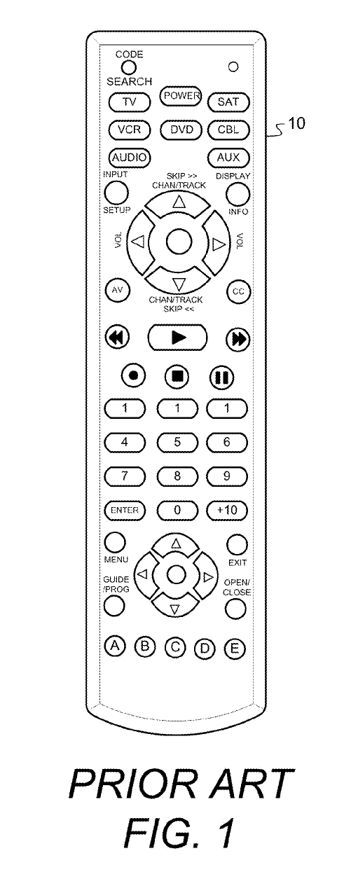

Universal remote controls are known in the prior art. FIG. 1 shows a universal remote control 10 known in the prior art. Those skilled in the art will recognize that the buttons on the prior art remote control 10 take up a large amount of space and may overwhelm or confuse users. It is also important to note that each button on the universal remote control is dedicated to a particular function and therefore the universal remote control is not capable of incorporating additional functions or devices without impractical physical modification.

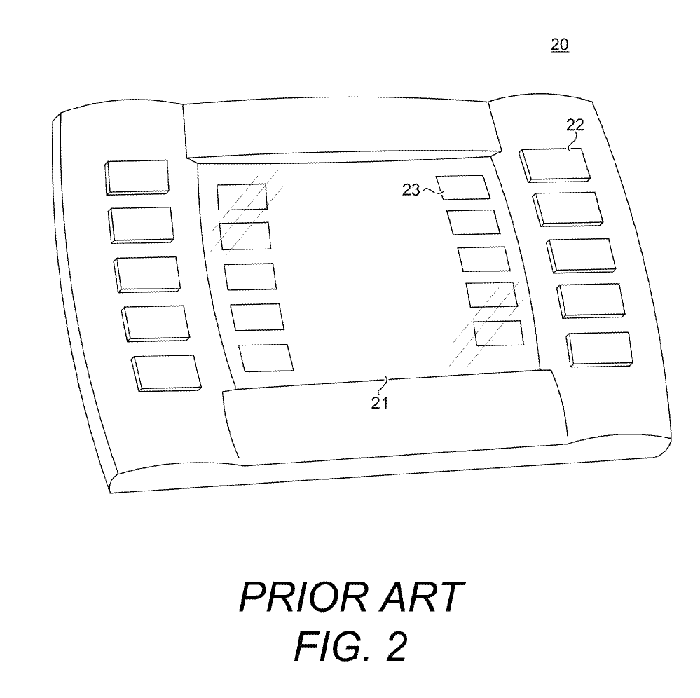

FIG. 2 shows a programmable remote control 20 known in the prior art. The programmable remote control 20 includes a display 21 which shows a graphic interface. The physical buttons 22 of the programmable remote control 20 are not dedicated to a particular function of the programmable remote control 20 but rather correspond to a menu option 23 listed next to the physical buttons 22 on the graphic interface. Control functions are listed as menu options 23 and are dynamic. The graphic interface may be modified through programming and offers the prior art programmable remote control 20 the flexibility to incorporate additional controllable devices and control functions without physically modifying the device. Because the control functions are listed on a programmable graphic interface, there is no limit as to the amount or type of control functions available to the remote control. However, those skilled in the art will recognize that the programmable remote control 20 does not make efficient use of space. Each menu option 23 requires a corresponding physical button 22. For the programmable remote control 20 to be a convenient size, the programmable remote control 20 can only display a limited amount of menu options on the display 21.

Recent prior art programmable remote controls have incorporated touch screens to overcome this limitation. Touch screens incorporate both a graphic interface and a physical interface in a display and provide additional flexibility and adaptability. The graphic interface of menu options displayed on a touchscreen can be laid out and programmed without regard to the location or number of any physical buttons.

Another recent advance is touch screens with multi-touch control. Multi-touch control capable touch screens recognize predefined sequences of simultaneous or successive finger gestures as corresponding to a single input or function.

There are significant disadvantages associated with equipping remote controls solely with a touch screen. In many remote control applications, touch screens are awkward and uncomfortable to use. Touch screen use for more than a few minutes adds significant stress to a user's fingers and can cause repetitive stress injuries (RSI). Despite these drawbacks there is a definite trend toward equipping remote controls solely with touch screens. Accordingly, there is a need for a remote control with the graphic interface flexibility of a touch screen and the ergonomic benefits of physical control buttons.

In addition, although users desire a remote control with a large display, touch screens limit the display size of devices as touch screens require a free hand for inputting. Remote controls with large touch screens, as in tablet remote controls, are difficult to hold with one hand and must be placed down to operate. Users have a natural inclination to grasp tablet devices with each hand in an open precision grip with the user's thumb finger above the top side of the tablet and the remaining four digit fingers on the bottom side supporting the tablet. Accordingly, there is a need for a tablet remote that may be easily operated while being held naturally by a user.

Users also desire a more convenient and capable graphic interface for remote controls. Those skilled in the art will recognize that prior art programmable remote controls organize the menu options of graphic interfaces as a multi-tier hierarchical menu, also called a tree menu. By separating menu options into discrete tiers, multi-tier hierarchical menus limit the number of menu options shown on the display at one time and provide the user a logical path of successive menu options to reach a desired control function.

However, there are significant disadvantages associated with multi-tier hierarchical menus. Multi-tier hierarchical menus require that the user make numerous inputs to reach his required control function. For example, channel up is an essential and commonly used control function of television remote controls. Because prior art television remote controls and universal remote controls include dedicated buttons that are immediately accessible, channel surfing with prior art television remote controls or universal remote controls is a passive experience, which users prefer.

Conversely, a user operating a prior art programmable remote control with a multi-tier hierarchical menu must select multiple menu options to reach the channel up control function. This is not a passive experience. To compound the problem, a user may only progress linearly up or down within a multi-tier hierarchical menu. Accordingly, there is a need for a remote control that utilizes a graphic interface that is easily navigable.

Taking into account these and other issues, there is a need for a remote control with the graphic interface flexibility of a touch screen and the ergonomic benefits of physical control buttons. There is also a need for a tablet remote that may be easily operated while being held naturally by a user. Finally, there is a need for a remote control that utilizes a graphic interface that is easily navigable.

### SUMMARY OF THE INVENTION

It is to be understood that both the general and detailed descriptions that follow are exemplary and explanatory only and are not restrictive of the invention.

### DISCLOSURE OF INVENTION

Accordingly, a need exists for a remote control controlled with the thumbs and operable without being placed down. The embodiments of the present invention provide these advantages and others not specifically mentioned above but described in the sections to follow.

According to a first aspect, the present invention provides a remote control unit, all the functions of which, are operable by both a first thumb and a second thumb of a user. The remote control comprises a top surface, a first control button, a second control button, a display screen, and a bottom surface. The top surface comprises a first edge and a second edge diametrically opposite the first edge. The first control button is positioned on the top surface of the remote control proximate to the first edge and is accessible to and actuatable by only the first thumb. The second control button is positioned on the top surface of the remote control proximate to the second edge and is simultaneously accessible to and actuatable by only the second thumb. The display screen is positioned on the top surface of the remote control between the first control button and second control button. The bottom surface is supported in space by one or more finger digits forming a first open precision grip with the first thumb and by one or more second finger digits forming an open precision grip with the second thumb, such that the first open precision grip is diametrically opposite the second open precision grip.

According to a second aspect, the present invention provides a remote control unit, all the functions of which, are operable by both a first thumb and a second thumb of a user. The remote control comprises a top surface, a first control button, a second control button, a display screen, and a bottom surface. The top surface comprises a first edge and a second edge diametrically opposite the first edge. The first control button is positioned on the top surface of the remote control proximate to the first edge and is accessible to and actuatable by only the first thumb. The second control button is positioned on the top surface of the remote control proximate to the second edge and is simultaneously accessible to and actuatable by only the second thumb. The display screen is positioned on the top surface of the remote control between the first control button and second control button and is configured for displaying a plurality of menu options organized into a gross level and a refined level. The gross level comprises a plurality of gross menu options and the refined level comprises a plurality of control menu options. The bottom surface is supported in space by one or more finger digits forming a first open precision grip with the first thumb and by one or more second finger digits forming an open precision grip with the second thumb, such that the first open precision grip is diametrically opposite the second open precision grip.

According to a third aspect, the present invention provides a method for operating a remote control comprising a first control button, a second control button and a display disposed between the first control button and second control button. The display is configured for displaying a plurality of menu options organized into gross level comprising a plurality of gross menu options and a refined level comprising a plurality of device groups. Each of the plurality of device groups comprises a plurality of control menu options. The method comprises the steps of: displaying the plurality of gross menu options on the display screen; navigating to one of the plurality of gross menu options by inputting one or more directional inputs to the first control button with a first thumb; selecting the one of the plurality of gross menu options by inputting a selection input to the first control button with the first thumb; displaying one of the plurality of device groups corresponding the one of the plurality of gross menu options on the display screen; navigating to one of the plurality of control menu options of the one of the plurality of device groups by inputting one or more directional inputs to the first control button with the first thumb; and selecting the one of the plurality of control menu options by inputting a selection input to the first control button with the first thumb.

### BRIEF DESCRIPTION OF DRAWINGS

The accompanying figures further illustrate the present invention.

The components in the drawings are not necessarily drawn to scale, emphasis instead being placed upon clearly illustrating the principles of the present invention. In the drawings, like reference numerals designate corresponding parts throughout the several views.

### BRIEF DESCRIPTION OF THE SEVERAL VIEWS OF THE DRAWING

FIG. 1 shows a universal remote control known in the prior art.

FIG. 2 shows a programmable remote control known in the prior art.

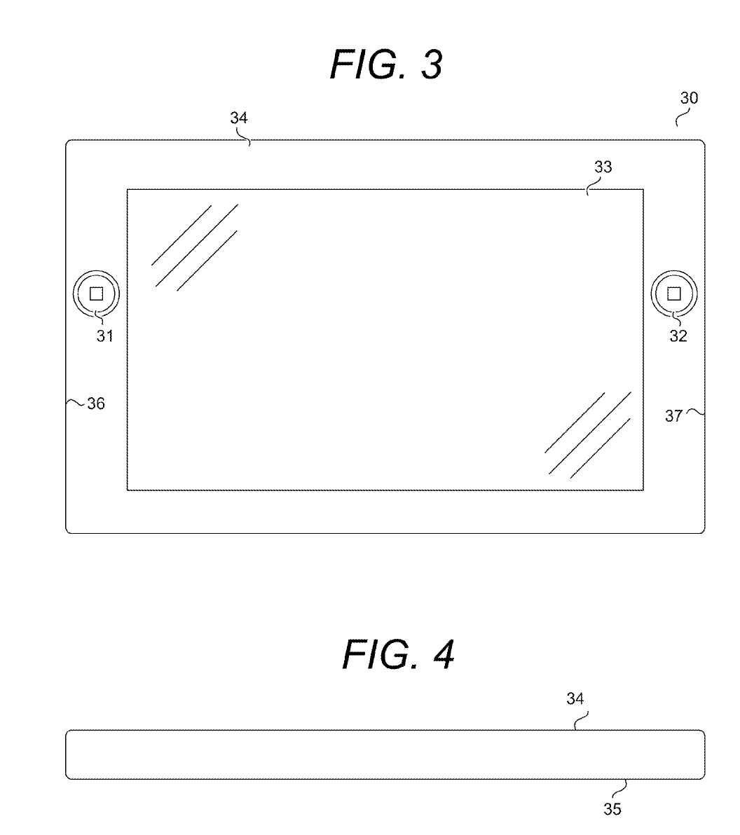

FIG. 3 is an illustrative drawing of the top surface of the remote control in accordance with one embodiment of the invention.

FIG. 4 is an illustrative drawing of a side view of the remote control in accordance with one embodiment of the invention.

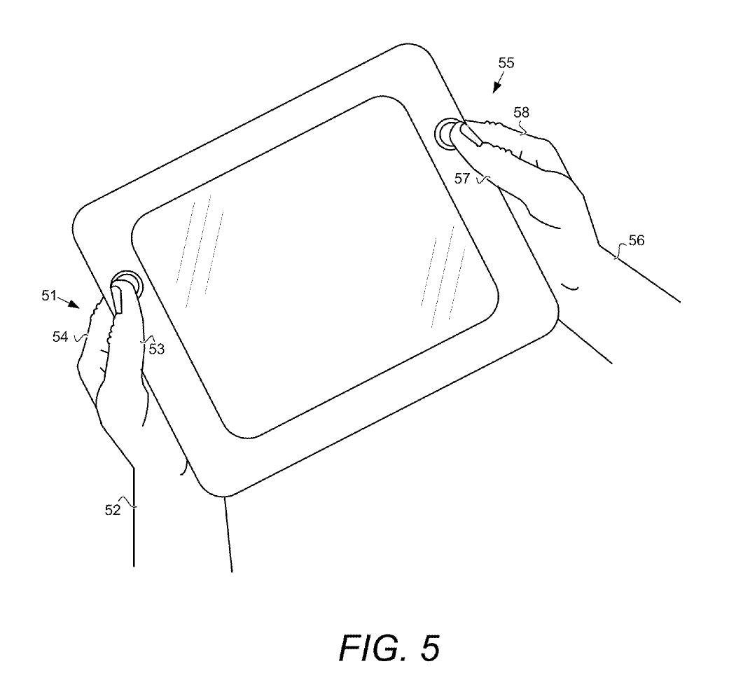

FIG. 5 is an illustrative drawing of the remote control of FIG. 3 being held in space during operation by a user.

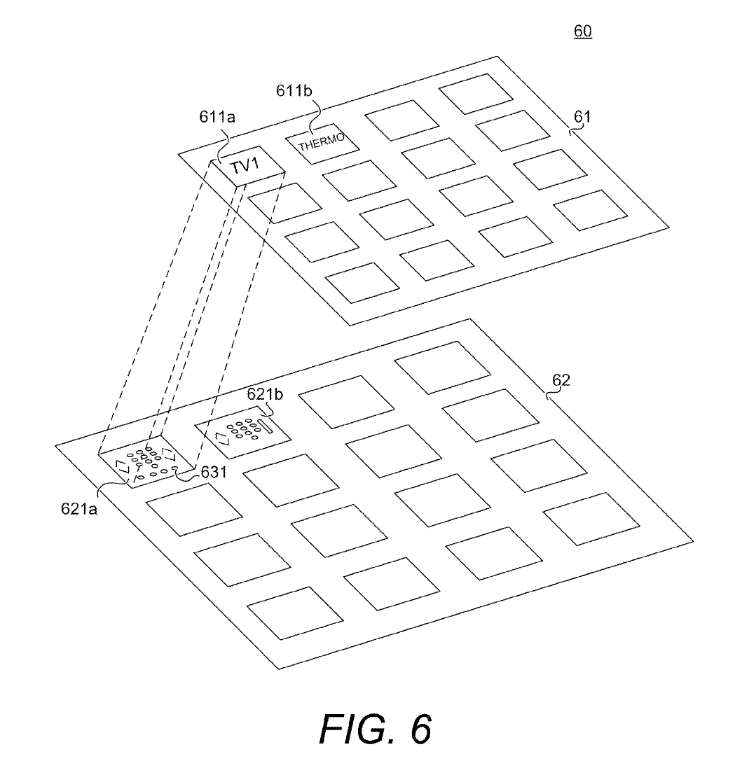

FIG. 6 is an illustrative depiction of a two-tier menu structure employed by the remote control of FIG. 3.

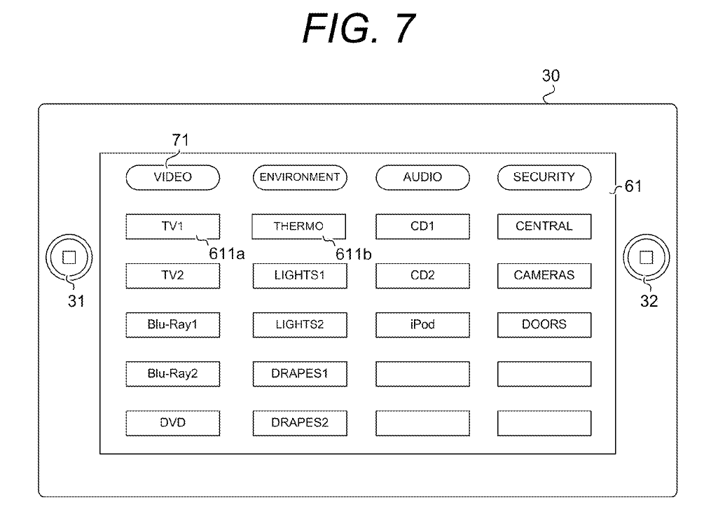

FIG. 7 is an illustrative drawing of the remote control of FIG. 3 displaying a gross level of a menu structure in accordance with one embodiment of the invention.

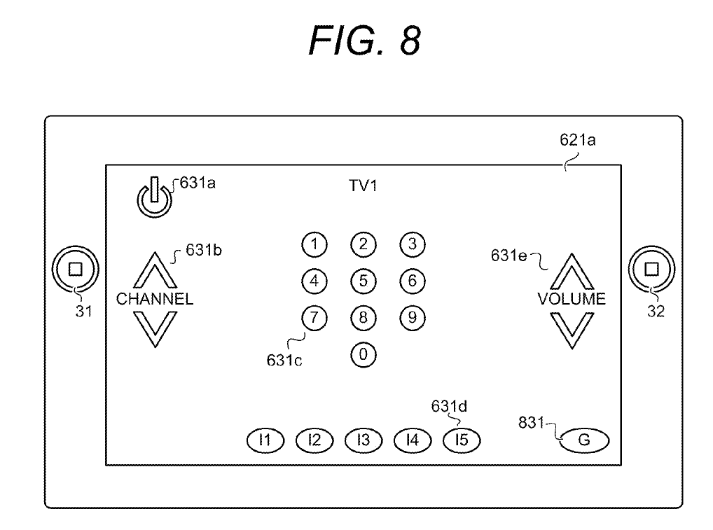

FIG. 8 is an illustrative drawing of the remote control of FIG. 3 displaying a TV1 device group in accordance with one embodiment of the invention.

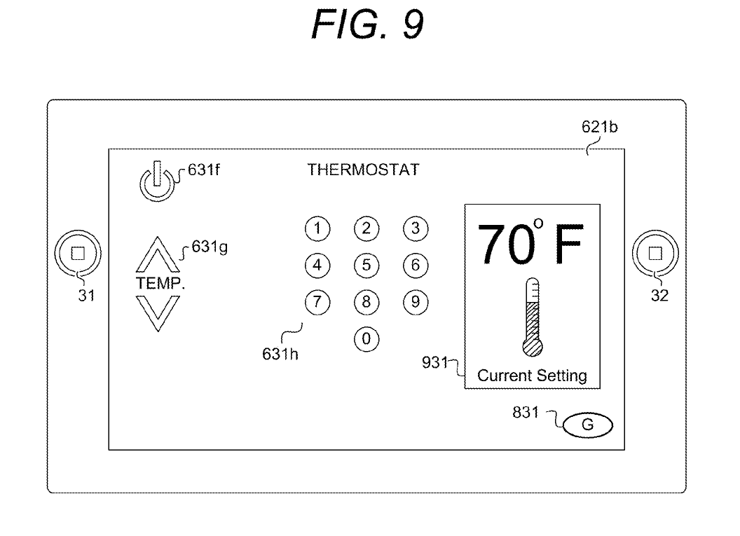

FIG. 9 is an illustrative drawing of the remote control of FIG. 3 displaying a THERMO device group in accordance with one embodiment of the invention.

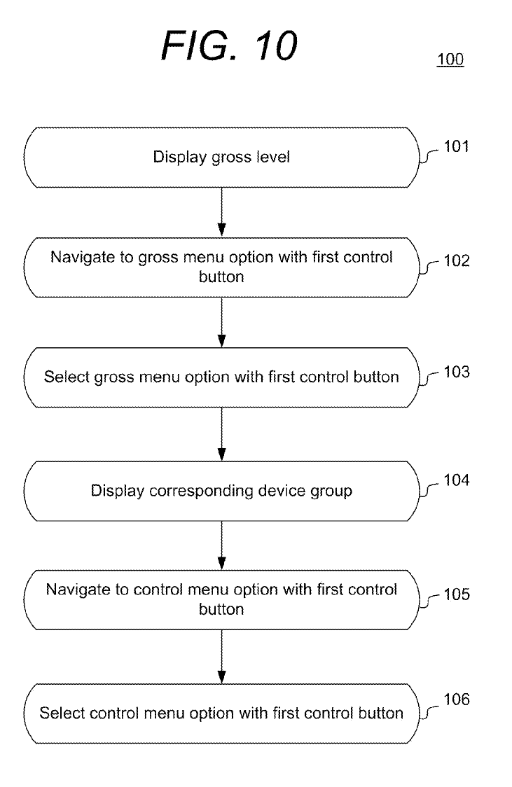

FIG. 10 is an illustrative flowchart for a method of operating a remote control with a menu organized into a gross level and a refined level in accordance with one embodiment of the invention.

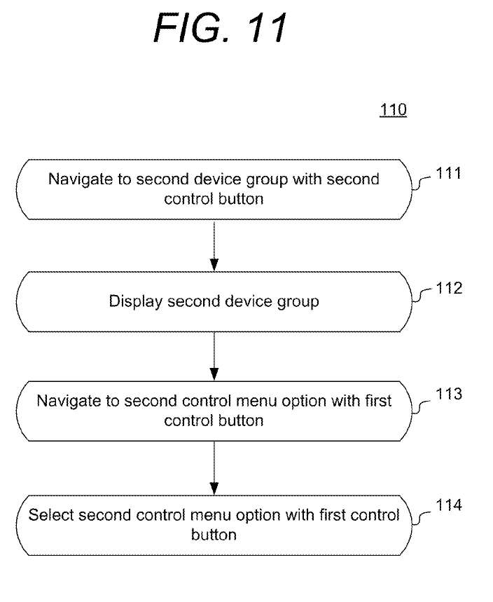

FIG. 11 is an illustrative flowchart for additional steps in the method of operating a remote control shown in FIG. 10 in accordance with one embodiment of the invention.

### LIST OF REFERENCE NUMBERS FOR THE MAJOR ELEMENTS IN THE DRAWING

The following is a list of the major elements in the drawings in numerical order.
10 prior art universal remote control
20 prior art programmable remote control
21 display screen (p/o programmable remote control 20)
22 physical control button (p/o programmable remote control 20)
23 graphical control button (p/o programmable remote control 20)
30 remote control
31 first control button (p/o remote control 30)
32 second control button (p/o remote control 30)
33 display screen (p/o remote control 30)
34 top surface (p/o remote control 30)
35 bottom surface (p/o remote control 30)
36 first edge (p/o remote control 30)
37 second edge (p/o remote control 30)
51 first open precision grip
52 first hand
53 first thumb
54 first digit fingers
55 second open precision grip
56 second hand
57 second thumb
58 second digit fingers
60 two-tier menu structure
61 gross level
62 refined level
71 column header
100 flowchart
101 (step of) displaying gross level
102 (step of) navigating to a gross menu option
103 (step of) selecting gross menu option
104 (step of) display corresponding device group
105 (step of) navigating to a control menu option
106 (step of) selecting control menu option
110 flowchart
111 (step of) navigating to a second device group
112 (step of) displaying second device group
113 (step of) navigating to a second control menu option
114 (step of) selecting a second control menu option
611 gross menu option (generally)
611a TV1 gross menu option
611b THERMO gross menu option
621 device group (generally)
621a TV1 device group
621b THERMO device group
631 control menu option (generally)
631a power control menu option
631b channel directional control menu options
631c channel numerical control menu options
631d source control menu options
631e volume control menu options
631f power control menu option
631g temperature directional control menu options
631h temperature numerical control menu options
831 return menu option
931 current temperature setting

### DETAILED DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### MODE(S) FOR CARRYING OUT THE INVENTION

The present invention involves a thumb-operated remote control and related methods of use. The remote control accepts user inputs and is capable of transmitting control commands to a plurality of controllable devices, such as audio and video components, lighting controls, and HVAC controls, and receiving feedback from controllable devices. The means for communicating with controllable devices is beyond the scope of this invention. However, those skilled in the art will recognize that the remote control may utilize many communication methods known in the prior art to transmit control commands either directly to the controllable device or indirectly through an intermediate device. For example, the remote control may transmit control commands as infrared (IR) or wireless radio frequency (RF) signals.

Referring now to the drawings, FIG. 3 shows a top view of the remote control 30 in accordance with one embodiment of the invention. The remote control 30 is a tablet comprising a first control button 31, a second control button 32, and a display screen 33. The display screen 33 is capable of displaying a graphic interface of menu options. The first control button 31 and second control button 32 are each capable of accepting directional inputs and selection inputs from the user and provide a physical interface for a user to both navigate and select within a graphic interface of the remote control 30.

In the preferred embodiment of the invention, the first control button 31 and second control button 32 are optical finger navigation (OFN) buttons, such as those offered by Avago Technologies. OFN buttons are known in the prior art and operate by using an infrared (IR) beam to track the motion of a finger across a top surface of the button. A finger gesture across the top surface of the OFN button inputs a directional input. A finger tap on the top surface of the OFN button inputs a selection input. OFN buttons have additional capabilities that are beneficial to the remote control 30 such as the capability to recognize various multi-touch gestures and to read fingerprint sequences. Although the first control button 31 and second control button 32 are preferably OFN buttons, those skilled in the art will recognize that any control button or combination of control buttons that are capable of providing a physical interface for a user to navigate and select within a graphic interface are suitable for use with the remote control 30.

The display screen 33 is configured for displaying the graphic interface of the remote control 30. Advantageously, as the remote control 30 is a tablet, the area of the display screen 33 is large in relation to the overall surface area of the remote control 30. The relative area of the display screen 33 is particularly useful for displaying menu options organized in a two-tier structure as will be discussed later in this section.

In the preferred embodiment of the invention, the display screen 33 is a touch screen. Although all functions of the remote control 30 are capable of being operated exclusively with the first control button 31 and second control button 32, the touch screen provides a secondary means for accepting user inputs. The touch screen may employ capacitive, resistive, acoustic, or optical touch sensors or any other suitable method for sensing touch. Although the display screen 33 in the preferred embodiment is a touch screen, those skilled in the art will recognize that the touch sensing aspect of the display screen 33 is a secondary consideration and any display screen capable of displaying a graphic interface can be used in alternative embodiments of the invention.

In one embodiment of the invention the first control button 31, second control button 32, and display screen 33 are situated on a top surface 34 of the remote control 30. The first control button is disposed proximate to a first edge 36 of the remote control 30. The second control button 32 is disposed proximate to a second edge 37 of the remote control 30 diametrically opposite to the first edge 36. The display screen 33 is positioned in the between the first control button and second control button 32. With this advantageous positioning of the first control button 31 and second control button 32, the user can comfortably and effectively operate the remote control 30 while holding the remote control with both hands.

FIG. 4 shows a side view of the remote control 30 according to one illustrative embodiment of the invention. In addition to the top surface 34, the remote control 30 has a bottom surface 35, which is diametrically opposite the top surface 34.

FIG. 5 is an illustrative drawing of the remote control 30 being held in space during operation by the user. The positioning of the first control button, second control button 32 and display screen 33 allow the user to operate the remote control 30 while holding the remote control 30 with both a first hand 52 in a first open precision grip 51 and a second hand 56 in a second open precision grip 55. One or more first digit fingers 54 and one or more second digit fingers 58 support a bottom surface 35 of the remote control 30. A first thumb 53 and a second thumb 57 are positioned above the first control button 31 and second control button 32, respectively, on the top surface 34 to complete the first open precision grip 51 and the second open precision grip 55.

The first control button 31 is actuatable exclusively by the first thumb 53 and the second button 32 is actuatable exclusively by the second thumb 57. The first control button 31 and the second control button 32 are capable of being actuated simultaneously by the user while holding the remote control 30 in space. By positioning the first control button 31 and second control button 32 under the first thumb 53 and the second thumb 57, the remote control 30 is operable without needing to be placed down on a surface, such as a table or a knee, by the user.

Users have a natural inclination to grasp tablet shaped objects with open precision grips as shown in FIG. 5. The remote control 30 takes advantage of the ergonomic benefits of this natural position and allows the user to avoid stress and injury during operation.

Additionally, due of the placement of the first control button 31 and second control button 32, the remote control 30 can take advantage of the increased functionality of the first thumb 53 and second thumb 57 as opposed to the first digit fingers 54 and second digit fingers 58. Thumb joints provide an increased range of motion compared to digit joints, and therefore are capable of performing wider variety of finger gestures. In one embodiment of the invention, the remote control 30 is programmed to recognize predefined sequences of finger gestures as a single predefined input or control command. The predefined sequence of finger gestures may comprise one or more finger gestures on a single control button, such as two consecutive circular motions on the first control button. The predefined sequence can also comprise simultaneous finger gestures on both the first control button 31 and second control button 32. For example, simultaneous up finger gestures on both the first control button 31 and the second control button 32 with the first thumb 53 and the second thumb 57, respectively, may correspond to a channel up control function of the remote control 30. By utilizing multi-touch capabilities, the remote control 30 provides quick access to commonly used control functions and provides the passive control experience that users prefer.

Those skilled in the art will recognize that additional functions and devices may be integrated into the remote control 30. As stated above, OFN buttons have the capability to read fingerprint patterns. In one embodiment of the invention, this capability is integrated into the remote control 30 to distinguish between users for security and customization purposes. The remote control 30 may also be equipped with a digital camera for taking pictures or speakers to aid hearing impaired users.

Thus far the remote control 30 has been explained in terms of its physical layout and orientation in the hands of a user. The remainder of this section describes the graphic interface of the remote control 30 and methods of using the remote control 30.

The display screen 33 is configured to display a graphic interface comprising selectable menu options. The organization of menu options of the graphic interface is adapted to take advantage of the physical orientation of the remote control 30 and is one feature that aids the remote control 30 in being effectively and comfortably controlled with a user's thumbs.

FIG. 6 is an illustrative depiction of the two-tier menu structure 60 employed by the remote control 30. The menu options are organized into two tiers, a gross level 61 and a refined level 62. The gross level 61 consists of the broadest level of menu options, gross menu options 611. Each gross menu option 611 corresponds to a controllable device of the remote control 30. For example, the TV1 gross menu option 611a corresponds to a controllable television designated “TV1” and the THERMO gross menu option 611b corresponds to a controllable thermostat designated “THERMO”.

The refined level 62 comprises control menu options 631 corresponding to control functions of the remote control 30. Control menu options 631 are grouped into device groups 621 and each gross menu option 611 of the gross level 61 is refined into a device group 621 of control menu options 631. Continuing with the above example, the TV1 gross menu option 611a is refined into a TV1 device group 621a of control menu options 631 for controlling “TV1”. The THERMO gross menu option 611b is refined into a THERMO device group 621b for controlling “THERMO”.

Device groups 621 are represented in FIG. 6 as cells and the control menu options 631 that make up the device group 621 are represented as icons within the cell. For clarity, only the individual control menu options 631 associated with the TV1 device group 621a and the THERMO device group 621b are shown in FIG. 6. However, those skilled in the art will recognize that each device group 621 shown in FIG. 6 comprises control menu options 631 corresponding to that device group's 621 associated gross menu option 611.

Device groups 621 are organized in relation to each other exactly as the device group's 621 associated gross menu options 611 are organized in relation to each other. For example, the TV1 gross menu option 611a is to the left and adjacent to the THERMO gross menu option 611b on the gross level 61 and the TV1 device group 621a of control menu options 631 is to the left and adjacent to the THERMO device group 621b on the refined level 62.

Refer to FIG. 7, which shows the remote control 30 displaying the gross level 61 of the two-tier menu structure 60 in accordance with one embodiment of the invention. In this embodiment of the invention, the display screen 33 is configured to display the gross level 61 in its entirety. In alternative embodiments of the invention where the quantity of gross menu options 611 makes it impractical to display all gross menu options 611 at once, the remote control 30 is configured to display a scrollable gross level 61 of gross menu options 611. In the embodiment shown in FIG. 7, the gross level 61 is displayed in entirety, with gross menu options 611 displayed as cells arranged in a matrix. Similar gross menu options 611 are organized in the same column with a column header 71 displayed above.

The user navigates between the gross menu options 611 of the gross level 61 by inputting directional inputs to a first control button. The user can navigate horizontally, vertically or diagonally among the gross menu options 611. Once the user has navigated to the desired gross menu option 611 he selects the gross menu option 611 by inputting a selection input to the first control button 31. In embodiments of the remote control 30 in which the first control button 31 and second control button 32 are OFN buttons, the user gestures across the first control button 31 in the desired direction to navigate between gross menu options 611 and taps the first control button 31 to select a desired gross menu option 611.

Once the desired gross menu option 611 is selected, the display screen 33 is configured to display the refined level 62 of the two-tier menu structure 60. Unlike the gross level 61, the display screen 33 does not display the entire refined level 62 but only the device group 621 corresponding to the selected gross menu option 611. For example, once the TV1 gross menu option 611a is selected, the display screen 33 will display the TV1 device group 621a.

FIG. 8 shows the remote control 30 displaying the TV1 device group 621a of the refined level 62 in accordance with one embodiment of the invention. Continuing with the above example, only the TV1 device group 621a of control menu options 631 is displayed once the TV1 gross menu option 611a is selected. The control menu options 631 in the TV1 device group 621a are a power control menu option 631a, channel directional control menu options 631b, channel numerical control menu options 631c, source control menu options 631d, and volume control menu options 631e. In addition to the control menu options 631 for controlling “TV1”, there is also a return menu option 831 which returns the remote control 30 to displaying the gross level 61.

Just as with the gross level 61, the user navigates between the control menu options 631 of the refined level 62 by inputting directional inputs to the first control button 31 and selects control menu options 631 by inputting a selection input to the first control button 31. In embodiments of the remote control 30 in which the first control button 31 and second control button 32 are OFN buttons, the user gestures across the first control button 31 in the desired direction to navigate between control menu options 631 and taps the first control button 31 to select a desired control menu option 631.

In further embodiments of the invention in which the OFN buttons are multi-touch capable, the user can input predefined sequences of inputs to both the first control button 31 and second control button 32 to quickly select control menu options 631. For example, while the remote control 30 is displaying the TV1 device group 621a, the user can simultaneously gesture both the first thumb up the first control button 31 and the second thumb up the second control button 32 to raise the volume of “TV1”.

In one embodiment of the invention, additional control menu options 631 for “TV1” are grouped in a separate device group 621 and correspond to a separate gross menu option 611. For example, control menu options 631 for adjusting the display of “TV1” are grouped in another device group 621, a TV1-Display device group, and accessed through another gross menu option 611, a TV1-Display gross menu option. However, in alternative embodiments of the remote control 30 all control menu options 631 for “TV1” are grouped in a single scrollable TV1 device group 621a. In another alternative embodiment of the remote control 30, the TV1 device group 621a may include control menu options 631 for commonly used functions such as power, channel controls and volume controls and a sub-level of the refined level 62 accessed through an option on the device group 621 includes less commonly used functions such as display settings.

Continue to refer to FIG. 8 and refer back to FIG. 6. Advantageously, with the remote control 30, it is not necessary for the user to return to the gross level 61 to access a different device group 621 of control menu options 631. The user may navigate from a device group 621 of control menu options 631 to an adjacent device group 621 of control menu options 631 with the second control button 32. While the remote control 30 is displaying the TV1 device group 621a as in FIG. 8, the user may navigate directly to the THERMO device group 621b by inputting a directional input to the right. The remote control 30 will then display the THERMO device group 621b of control menu options 631 for “THERMO”. In one embodiment of the remote control 30, the user can navigate vertically, horizontally and diagonally successively to adjacent device groups 621. In another embodiment of the remote control, the user can navigate directly to a desired device group 621 with navigating successively to adjacent device groups 621.

In embodiments of the remote control 30 in which the first control button 31 and second control button 32 are OFN buttons, the user navigates to an adjacent device group 621 of control menu options 631 by gesturing a finger in that direction. As the user becomes more familiar with the organization of device groups 621 within the refined level 62, he can quickly access the desired device group 621 and corresponding control menu options 631.

Refer to FIG. 9 while continuing to refer to FIG. 8. FIG. 9 shows the remote control 30 displaying the THERMO device group 621b of the refined level 62 in accordance with one embodiment of the invention. The control menu options 631 in the THERMO device group 621b are power control menu option 631f, temperature directional control menu options 631g, temperature numerical control menu options 631h. In addition to the control menu options 631 for controlling “THERMO”, there is also the return menu option 831 which returns the remote control 30 to displaying the gross level 61 and a current temperature setting 931 that shows the current setting of “THERMO”.

In embodiment of the remote control 30, the device groups 621 of the refined level 62 are displayed in a format that is intuitive to the user. Control menu options 631 from one device group 621 that are similar to control menu options 631 of other device groups 621 are displayed in like positions in each device group 621. For example, the channel directional control menu options 631b and the temperature directional control menu options 631g are located in similar locations on the TV1 device group 621a and the THERMO device group 621b. This applies for power control menu option 631a and power control menu option 631f, as well as channel numerical control menu options 631c and temperature numerical control menu options 631h.

Additionally, in embodiments of the remote control 30, control menu options 631 are displayed as graphic representations of their physical analogues. For example, the control menu options 631 of the THERMO device group 621b are graphically displayed on the remote control as they physically appear as buttons and displays on the “THERMO” thermostat. The current temperature setting is displayed and positioned within the device group 621 on the remote control as a current temperature display screen is displayed and positioned on the “THERMO” thermostat.

FIG. 10 shows a process flowchart 100 for a method of operating a remote control 30 comprising a first control button 31, a second control button 32 and a display screen 33 configured for displaying a plurality of menu options organized into a gross level 61 and a refined level 62. The gross level 61 of menu options comprises a plurality of gross menu options 611 and the refined level 62 of menu options comprises a plurality of device groups 621. Each device group further comprises a plurality of control menu options 631. FIG. 11 shows a process flowchart 110 for additional steps in the method of operating the remote control 30 shown in FIG. 10.

Flowchart 100 and flowchart 110 include processes of the present invention which, in one embodiment, are carried out by a processor and electrical components under the control of computer readable and computer executable instructions. The computer readable and computer executable instructions may reside, for example, in data storage features such as computer usable memory or in any other type of computer readable medium. Although specific steps are disclosed in flowchart 100 and flowchart 110, such steps are exemplary. That is, the present invention is well suited to performing various other steps or variations of the steps recited in FIG. 10 and FIG. 11. Within the present embodiment, it should be appreciated that the steps of flowchart 100 and 110 can be performed by software or hardware or any combination of software and hardware.

Refer to FIG. 10 and back to FIG. 7. According to an illustrative embodiment of the present invention, the remote control 30 displays (step 101) the gross level 61 of gross menu options 611 in its entirety on the display screen 33. The user navigates (step 102) to a desired gross menu option 611 by inputting one or more directional inputs to the first control button 31 with a first thumb 53. Once the user has navigated to the desired gross menu option 611, for example the TV1 gross menu option 611a, he selects (step 103) the gross menu option 611 by inputting a selection input to the first control button 31 with the first thumb 53. The remote control 30 then displays (step 104) the corresponding device group 621 of control menu options 631, the TV1 device group 621a, on the display screen 33. Refer back to FIG. 8. The user navigates (step 105) to a desired control menu option 631 of the device group 621 by inputting one or more directional inputs to the first control button 31 with the first thumb 53. Once the user has navigated to the desired control menu option 631, for example the channel directional control menu options 631b, he selects (step 106) the control menu option 631 by inputting a selection input to the first control button 31 with the first thumb 53.

Advantageously, the entire method outlined in FIG. 10 can be carried out with the user holding the remote control 30 in space with both a first thumb 53 and one or more first digit fingers 54 in a first open precision grip 51 and a second thumb 57 and one or more second digit fingers 58 in a second open precision grip 55, as shown in FIG. 5.

Refer to FIG. 11 and back to FIG. 8. Advantageously, a user can select a control menu option 631 from a second device group 621 without returning to the gross level 61 of the menu. While the remote control 30 is displaying the corresponding device group 621 as described above, for example the TV1 device group 621a, the user navigates (step 111) to a second device group 621, for example the THERMO device group 621b, by inputting one or more directional inputs to the second control button 32 with a second thumb 57. The remote control 30 then displays (step 112) the second device group 621, the THERMO device group 621b, on the display screen 33. The user navigates (step 113) to a second desired control menu option 631, for example the temperature directional control menu options 631g, within the second device group 621 by inputting one or more directional inputs to the first control button 31 with a first thumb 53. Once the user has navigated to the second desired control menu option 631 he selects (step 114) the control menu option 631 by inputting a selection input to the first control button 31 with a first thumb 53.

Advantageously, the entire method outlined in FIG. 11 can be carried out with the user holding the remote control 30 in space with both a first thumb 53 and one or more first digit fingers 54 in a first open precision grip 51 and a second thumb 57 and one or more second digit fingers 58 in a second open precision grip 55, as shown in FIG. 5.

In summary, embodiments of the present invention provide a remote control with a two-tier menu structure operated with the thumbs and methods of using such device.

### INDUSTRIAL APPLICABILITY

To solve the aforementioned problems, the present invention is a unique tablet remote control displaying a two-tier menu structure and which can be operated by user with only a first thumb and a second thumb while holding the remote control in space.

### LIST OF ACRONYMS USED IN THE DETAILED DESCRIPTION OF THE INVENTION

The following is a list of the acronyms used in the specification in alphabetical order.

HVAC heating, ventilation, and air conditioning

IR infrared

OFN optical finger navigation

RF radio frequency

RSI repetitive strain injury

### Alternate Embodiments

Alternate embodiments may be devised without departing from the spirit or the scope of the invention. For example, in alternative embodiments the first control button and the second control button may be joysticks.

What is claimed is:

1. A remote control unit, all the functions of which, are operable by both a first thumb and a second thumb of a user, said remote control unit comprising:
a top surface comprising a first edge and a second edge diametrically opposite the first edge;
a first control button positioned on the top surface of the remote control unit proximate to the first edge, the first control button being accessible to, and actuatable by, only the first thumb;
a second control button positioned on the top surface of the remote control unit proximate to the second edge, the second control button being simultaneously accessible to, and actuatable by, only the second thumb;
a display screen positioned on the top surface of the remote control unit between the first control button and the second control button; and
a bottom surface supported in space by one or more first finger digits forming a first open precision grip with the first thumb and by one or more second finger digits forming an a second open precision grip with the second thumb, such that the first open precision grip is diametrically opposite the second open precision grip.

2. The remote control unit of claim 1, wherein the first control button and the second control button each comprise an optical finger navigation button.

3. The remote control unit of claim 1, configured for recognizing a predefined sequence of actuations of the first control button and the second control button as a single predefined user input.

4. The remote control unit of claim 1, wherein the display screen is configured for displaying a plurality of menu options organized into a gross level and a refined level.

5. The remote control unit of claim 4, wherein the gross level comprises a plurality of gross menu options and the refined level comprises a plurality of device groups, each of the device groups comprising a plurality of control menu options, and wherein each of said plurality of device groups corresponds to a different one of said plurality of gross menu options of the gross level.

6. The remote control unit of claim 5, wherein the display screen is configured to display all of the plurality gross menu options.

7. The remote control unit of claim 5, wherein the display screen is configured for displaying one of the plurality of device groups at a time.

8. The remote control unit of claim 5, wherein the first control button is configured for navigating between said plurality of gross menu options and between said plurality of control menu options and the second control button is configured for navigating between said plurality of device groups.

9. The remote control unit of claim 5, wherein the control menu options are displayed as graphic representations of corresponding physical controls.

10. A remote control unit, all the functions of which, are operable by both a first thumb and a second thumb of a user, said remote control unit comprising:
a top surface comprising a first edge and a second edge diametrically opposite the first edge;
a first control button positioned on the top surface of the remote control unit proximate to the first edge, the first control button being accessible to, and actuatable by, only the first thumb;
a second control button positioned on the top surface of the remote control unit proximate to the second edge, the second control button being simultaneously accessible to, and actuatable by, only the second thumb;
a display screen positioned on the top surface of the remote control unit between said first control button and said second control button and configured for displaying a plurality of menu options organized into a gross level and a refined level, said gross level comprising a plurality of gross menu options and said refined level comprising a plurality of control menu options; and
a bottom surface supported in space by one or more first finger digits forming a first open precision grip with the first thumb and by one or more second finger digits forming a second open precision grip with the second thumb, such that the first open precision grip is diametrically opposite the second open precision grip.

11. The remote control unit of claim 10, wherein the display screen is configured to display all of the plurality of gross menu options.

12. The remote control unit of claim 10, wherein the display screen is configured to display one of a plurality of device groups at a time.

13. The remote control unit of claim 10, wherein the first control button and the second control button each comprise an optical finger navigation button.

14. The remote control unit of claim 10, wherein the remote control unit is configured for recognizing a predefined sequence of inputs as a single predefined user input.

15. A method for operating a remote control unit comprising a first control button, a second control button and a display screen disposed between the first control button and second control button, the display screen being configured for displaying a plurality of menu options organized into a gross level comprising a plurality of gross menu options and a refined level comprising a plurality of device groups, each of the plurality of device groups comprising a plurality of control menu options, said method comprising the steps of:
displaying the plurality of gross menu options on the display screen;
navigating to one of the plurality of gross menu options by inputting one or more directional inputs to the first control button with a first thumb;
selecting the one of the plurality of gross menu options by inputting a selection input to the first control button with the first thumb;
displaying one of the plurality of device groups corresponding to the one of the plurality of gross menu options on the display screen;
navigating to one of the plurality of control menu options of the one of the plurality of device groups by inputting one or more directional inputs to the first control button with the first thumb; and
selecting the one of the plurality of control menu options by inputting a selection input to the first control button with the first thumb.

16. The method of claim 15, further comprising the steps of:
directly navigating from the one of the plurality of device groups to a another of the plurality of device groups by inputting one or more directional inputs to the second control button with a second thumb;
displaying the another of the plurality of device groups on the display screen of the remote control unit;
navigating to one of the plurality of control menu options of the another of the plurality of device groups by inputting one or more directional inputs to the first control button with the first thumb; and
selecting the one of the plurality of control menu options of the another of the plurality of device groups by inputting a selection input to the first control button with the first thumb.
